(19) United States
(12) Patent Application Publication
(10) Pub. No.: US 2004/0208143 A1
(43) Pub. Date: Oct. 21, 2004

(54) Receiving apparatus and a controlling method of the receiving apparatus

(75) Inventor: Taku Nagase, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: SONY ERICSSON MOBILE COMMUNICATIONS JAPAN, INC., Tokyo (JP)

(21) Appl. No.: 10/811,911

(22) Filed: Mar. 30, 2004

(30) Foreign Application Priority Data
Apr. 18, 2003 (JP) 2003-113895

(51) Int. Cl. H04Q 7/00

(52) U.S. Cl. 370/331; 370/335

(57) ABSTRACT

The invention aims to decrease a processing load and power consumption for a path searcher during a soft hand-over process and fast search for multipath signals. The invention is so configured that correlation integrators 18a through 18h are divided into a group to search a base station as hand-over origin for multipath signals and another group to search a base station as hand-over destination for multipath signals. This makes it possible to simultaneously search the base stations as hand-over origin and destination for multipath signals. Consequently, a single process can search the base stations as hand-over origin and destination for multipath signals. It is possible to decrease a processing load and power consumption for the path searcher during the soft hand-over process. In addition, multipath signals can be searched fast.

### FIELD OF THE INVENTION

The present invention relates to a receiving apparatus having a path searcher to search for multipath signals used for rake combination and a controlling method of the receiving apparatus. More specifically, the present invention concerns a technology capable of decreasing processing loads and power consumption for the path searcher during a soft hand-over process, and fast searching for multipath signals.

### BACKGROUND OF THE INVENTION

Generally, a CDMA (Code Division Multiple Access) compliant communication apparatus can independently receive a plurality of reception signals each reaching a reception section at different times via different transmission paths. Such reception signal is hereafter referred to as a multipath signal. The communication apparatus then performs a so-called rake combination to combine the received multipath signals for improving reception characteristics.

A receiving apparatus performs the above-mentioned rake combination. Normally, the receiving apparatus individually receives and combines signals from a plurality of base stations during hand-over to improve reception characteristics during hand-over. In addition, the receiving apparatus performs a so-called soft hand-over process (or a diversity hand-over process) to prevent speech discontinuity during hand-over (e.g., see patent document 1).

The above-mentioned hand-over is defined as follows. While the receiving apparatus moves, it communicates with a plurality of base stations one after another. In this situation, the hand-over provides a process to switch from one base station to an adjacent one to continue the communication.

### Patent Document 1

### JP-A No. 50338/2000

The receiving apparatus to perform the above-mentioned rake combination is normally provided with a path searcher. The path searcher searches for multipath signals used for the rake combination by using time resolution of a spread code to detect a multipath signal present in a specified time range.

However, a conventional path searcher operates in its entirety during the soft hand-over process to search each base station to communicate with for multipath signals. Accordingly, the soft hand-over process causes a large processing load and power consumption. In addition, it is impossible to fast search for multipath signals.

### SUMMARY OF THE INVENTION

The present invention has been made in consideration of the foregoing. It is therefore an object of the present invention to provide a receiving apparatus and its controlling method capable of decreasing a processing load and power consumption of the path searcher during soft hand-over and fast searching for multipath signals.

A receiving apparatus according to the present invention and its controlling method are characterized as follows. The receiving apparatus comprises a rake reception section to combine and output a plurality of reception signals obtained via different transmission paths, a plurality of correlation integrators, and a path searcher to search for the plurality of reception signals based on a correlative integration value calculated by the correlation integrator with respect to a reception signal. The controlling method concerns this receiving apparatus. The plurality of correlation integrators is divided into groups in correspondence with the number of base stations to communicate with. A base station is assigned to each of the groups. The correlation integrators in each group are controlled so as to calculate a correlative integration value with respect to a reception signal from an assigned base station.

That is to say, the present invention divides a plurality of correlation integrators into groups in correspondence with the number of base stations with which the path searcher communicate. The correlation integrators in each group search an assigned base station for multipath signals. As a result, it is possible to decrease a processing load and power consumption for the path searcher during a soft hand-over process and fast search for multipath signals.

### BRIEF DESCRIPTION OF THE DRAWINGS

FIG. 1 is a block diagram showing a configuration of the receiving apparatus according to an embodiment of the present invention;

FIG. 2 is a block diagram showing an inside configuration of the path searcher shown in FIG. 1; and

FIG. 3 shows a distribution state (delay profile) of multipath signals.

### DETAILED DESCRIPTION OF THE PREFERRED EMBODIMENTS

Embodiments of the present invention will be described in further detail with reference to the accompanying drawings.

### Receiving Apparatus Configuration

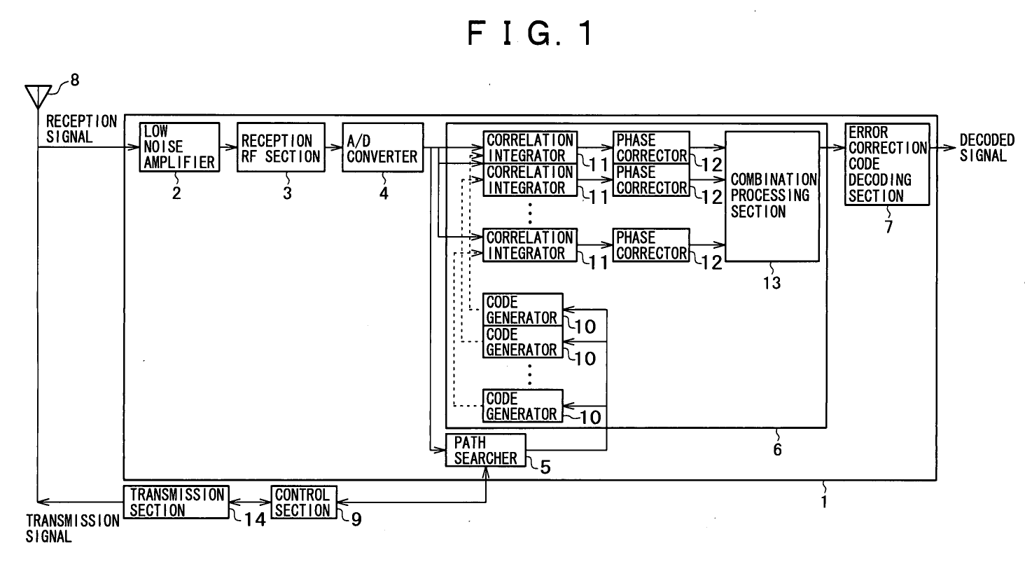

As an embodiment of the present invention, a receiving apparatus 1 is applicable to a reception section of a CDMA compliant cellular phone, for example. As shown in FIG. 1, the receiving apparatus 1 mainly comprises a low noise amplifier (LNA) 2, a reception RF (radio frequency) section 3, an A/D (analog/digital) converter 4, a path searcher 5, a rake reception section 6, and an error correction code decoding section 7.

The low noise amplifier 2 amplifies a high-frequency reception signal received at an antenna 8 and supplies the amplified reception signal to the reception RF section 3. The reception RF section 3 applies frequency conversion (down conversion) to the reception signal supplied from the low noise amplifier 2 to generate a baseband signal. Further, the reception RF section 3 supplies the generated baseband signal to the A/D converter 4.

The A/D converter 4 converts the analog reception signal supplied from the reception RF section 3 into a digital signal. The A/D converter 4 then supplies the digitized reception signal to the path searcher 5 and the rake reception section 6.

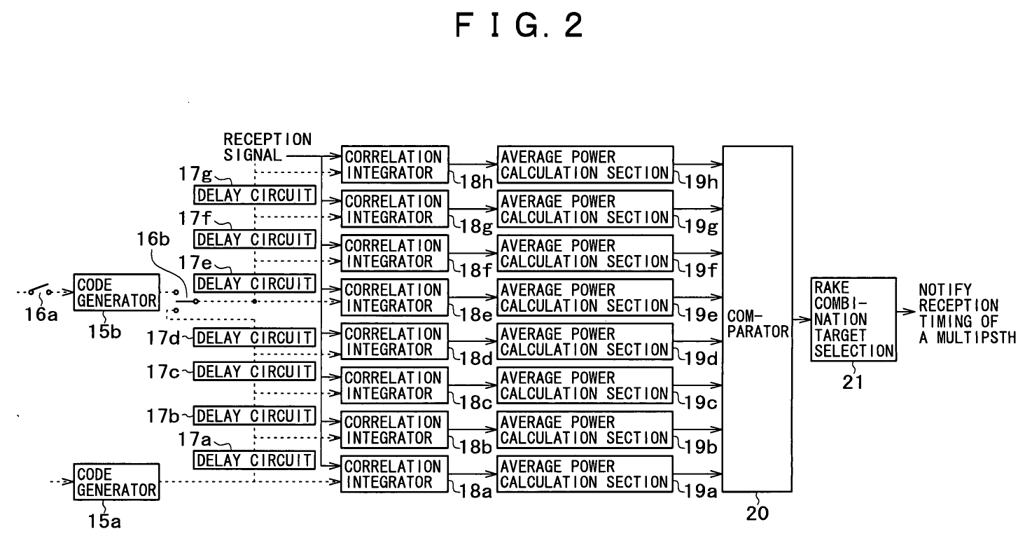

The path searcher 5 searches reception signals supplied from the A/D converter 4 for a multipath signal. To do this, the A/D converter 4 follows a command from a control section 9 such as a CPU (Central Processing Unit) and a DSP (Digital Signal Processor) in the cellular phone. The configuration and operations of the path searcher 5 will be described later in detail with reference to FIG. 2.

The rake reception section 6 comprises a plurality of code generators 10, a plurality of correlation integrators 11, a plurality of phase correctors 12, and a combination processing section 13. The code generator 10 generates a spread code. The correlation integrator 11 calculates (despreads) a correlative integration value between the spread code generated by the code generator 10 and the reception signal. The phase corrector 12 corrects a phase of the correlative integration signal calculated by the correlation integrator 11. The combination processing section 13 combines a plurality of correlative integration signals phase-corrected by the phase corrector 12. In addition, the rake reception section 6 rake-combines and outputs a plurality of multipath signals in accordance with a search result of multipath signals by the path searcher 5. Here, it is assumed that the numbers of code generators, correlation integrators, and phase correctors correspond to the number of multipath signals to be rake-combined. Operations of the rake reception section 6 will be described later in detail.

The error correction code decoding section 7 performs error detection using an error correction code such as the Reed-Solomon code for a rake combination signal supplied from the rake reception section 6. Based on a detection result, the error correction code decoding section 7 performs error correction for the rake combination signal. The error correction code decoding section 7 then decodes the error-corrected rake combination signal and outputs it as a decoded signal.

### Path Searcher Configuration

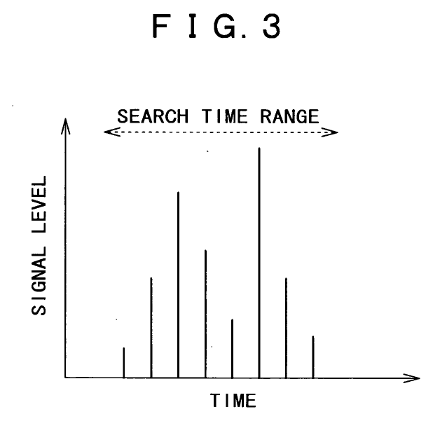

As shown in FIG. 2, the path searcher 5 comprises code generators 15a and 15b, switch circuits 16a and 16b, a plurality of serially connected delay circuits 17a through 17g, and a plurality of correlation integrators 18a through 18h. The path searcher 5 further comprises average power calculation sections 19a through 19h corresponding to the correlation integrators, a comparator 20, and a rake combination target selection section 21. The path searcher 5 detects reception timings (reception times) of multipath signals contained in a specified time range as shown in FIG. 3. The path searcher 5 then notifies the rake reception section 6 of the reception timings of multipath signals.

The code generators 15a and 15b generate spread codes in accordance with a command from the control section 9 (see FIG. 1). The code generators 15a and 15b generate the same spread code as that used by a transmission section 14 (see FIG. 1) in the cellular phone for modulation of a transmission signal. While the embodiment uses two code generators, the number of code generators is configured to match the number of base stations to communicate with.

The switch circuit 16a selects connection or disconnection between the control section 9 and the code generator 15b according to a command from the control section 9. When the spread code is supplied to the delay circuit 17e and the correlation integrator 18e, the switch circuit 16b selects the supply of the spread code between the delay circuit 17d and the code generator 15b according to a command from the control section 9. The number of switch circuits is configured to match the number of code generators.

The delay circuits 17a through 17g comprise elements such as buffer memory and delay a spread code phase at a specified timing. The delay circuits 17a through 17g then input the delayed spread code to the correlation integrator. This changes a reception timing to generate a correlative integration value (to be described) between the correlation integrators 18a through 18h.

The correlation integrators 18a through 18h perform correlative integration (despread) using the spread code and the reception signal supplied from the reception RF section 3 to generate a correlative integration signal. The generated correlative integration signal is input to the average power calculation sections 19a through 19h. Here, the correlative integration multiplies the spread code and the reception signal together, integrates a signal resulting from the multiplication for a specified period of time, and outputs the integrated signal.

The average power calculation sections 19a through 19h convert the input correlative integration signal into an average power value and supply the average power value to the comparator 20. The comparator 20 compares sizes of the input average power values and supplies a comparison result to the rake combination target selection section 21.

Based on the comparison result supplied from the comparator 20, the rake combination target selection section 21 determines average power values from the highest to a specified ordinal position. The determined average power value is output from the correlation integrator that generated the correlative integration value at a reception timing. The rake combination target selection section 21 notifies this timing as the reception timing of the multipath signal to the code generator 10 in the rake reception section 6. The number of multipath signal reception timings notified by the rake combination target selection section 21 is configured to be smaller than or equal to the number of code generators 10.

### Path Searcher Operations

### Normal Operation

The path searcher 5 performs a normal operation to search for a multipath signal concerning one base station. During this operation, the switch circuit 16a electrically disconnects the code generator 15b from the control section 9 according to a normal operation command from the control section 9. In response to the normal operation command from the control section 9, the switch circuit 16b operates to supply the spread code from the delay circuit 17d to the delay circuit 17e and the correlation integrator 18e. In this manner, all the correlation integrators 18a through 18h perform correlative integration using the spread code generated by the code generator 15a. In response to the normal operation command, the code generator 15a generates and outputs the same spread code as that used by the transmission section 14 to transmit signals to the base station.

### Soft Hand-Over Process

The soft hand-over process searches base stations as hand-over origin and destination for multi path signals. During this process, the switch circuit 16a electrically connects the control section 9 and the code generator 15b in response to a soft hand-over process command from the control section 9. The switch circuit 16b operates to supply the spread code from the code generator 15b to the delay circuit 17e and the correlation integrator 18e in response to the soft hand-over process command from the control section 9. In this manner, the correlation integrators 18a through 18d are supplied with the spread code generated by the code generator 15a. The correlation integrators 18e through 18h are supplied with the spread code generated by the code generator 15b.

In response to a command from the control section 9, the code generators 15a and 15b generate spread codes corresponding to the base stations as hand-over origin and destination. In this manner, the correlation integrators 18a through 18d and the correlation integrators 18e through 18h respectively search the base stations as hand-over origin and destination for multipath signals. It becomes possible to simultaneously search a plurality of base stations for multi path signals.

This operation decreases the number of correlation integrators assigned to search one base station for multipath signals. Consequently, the operation narrows a range of time to search each base station for multipath signals compared to the normal operation, and decreases the number of multipath signals to be found for one base station. However, the soft hand-over process can provide a diversity gain by combining multipath signals obtained from a plurality of base stations. Therefore, it is possible to obtain a rake combination signal having a sufficient level.

### Operations of the Rake Reception Section

As mentioned above, the code generator 10 is notified of the reception timing of multipath signals used for the combination process from the rake combination target selection section 21. According to the notified reception timing, the code generator 10 generates a spread code corresponding to the multipath signal. The code generator 10 then supplies the generated spread code to the correlation integrator 11.

When supplied with the spread code, the correlation integrator 11 performs correlative integration (despread) using the supplied spread code and the reception signal. In this manner, the correlation integrator 11 generates a correlative integration signal corresponding to the multipath signal. The correlation integrator 11 supplies the generated correlative integration signal to the phase corrector 12.

When supplied with the correlative integration signal, the phase corrector 12 corrects its phase so as to equalize phases of correlative integration signals output from the correlation integrators. The phase corrector 12 supplies phase-corrected correlative integration signals to the combination processing section 13. Finally, the combination processing section 13 combines a plurality of supplied correlative integration signals to generate a combination signal. The generated combination signal is input to the error correction code decoding section 7.

As clearly understood from the above-mentioned description, the receiving apparatus 1 according to the embodiment of the present invention does not use all correlation integrators for each of the base stations as hand-over origin and destination during the soft hand-over process. Instead, the receiving apparatus 1 divides the correlation integrators 18a through 18h into a group to search the base station as hand-over origin for multipath signals and another group to search the base station as hand-over destination for multipath signals. In this manner, the receiving apparatus 1 simultaneously searches the base stations as hand-over origin and destination for multipath signals. According to this constitution, a single process can search the base stations as hand-over origin and destination for multipath signals. It is possible to decrease a processing load and power consumption for the path searcher during the soft hand-over process. In addition, multipath signals can be searched fast.

### Other Embodiments

While there has been described constitutions and operations of the embodiment according to the invention made by the inventors, the present invention is not limited by any descriptions and drawings constituting part of the disclosure of the present invention according to the embodiment. For example, the above-mentioned embodiment provides eight correlation integrators in the path searcher 5 for searching for eight multipath signals. It may be preferable to provide more correlation integrators to be able to search for more multipath signals. It may be also preferable to chronologically switch between operation timings of the correlation integrators in a time-sharing manner to be able to search for more multipath signals without increasing the number of correlation integrators. According to the above-mentioned embodiment, the path searcher 5 searches for multipath signals in accordance with average power values. It may be preferable to search for multipath signals in accordance with average amplitudes. To sum up, the categories of the present invention include all the other embodiments, examples, operational technologies, and the like made by those skilled in the art based on the above-mentioned embodiment.

As mentioned above, the receiving apparatus according to the present invention can decrease a processing load and power consumption for the path searcher during a soft hand-over process and fast search for multipath signals.

1. A receiving apparatus comprising:
a rake reception section to combine and output a plurality of reception signals obtained via different transmission paths;
a plurality of correlation integrators; and
a path searcher to search for the plurality of reception signals based on a correlative integration value calculated by said correlation integrator with respect to a reception signal,
wherein said path searcher divides said plurality of correlation integrators into groups in correspondence with the number of base stations to communicate with, assigns a base station to each of the groups, and controls said correlation integrators in each group so as to calculate a correlative integration value with respect to a reception signal from an assigned base station.

2. The receiving apparatus according to claim 1,
wherein, during a soft hand-over process, said path searcher divides said plurality of correlation integrators into a group to calculate a correlative integration value with respect to a reception signal from a base station as hand-over origin and another group to calculate a correlative integration value with respect to a reception signal from a base station as hand-over destination.

3. A controlling method of a receiving apparatus comprising a rake reception section to combine and output a plurality of reception signals obtained via different transmission paths, a plurality of correlation integrators, and a path searcher to search for the plurality of reception signals based on a correlative integration value, calculated by said correlation integrator, with respect to a reception signal, said method comprising the steps of:
grouping said plurality of correlation integrators in correspondence with the number of base stations to communicate with;
assigning a base station to each of the groups thus grouped; and
controlling correlation integrators in each group so as to calculate a correlative integration value with respect to a reception signal from an assigned base station.

4. The controlling method of a receiving apparatus according to claim 3,
wherein, during a soft hand-over process, said step of grouping a plurality of correlation integrators divides said plurality of correlation integrators into a group to calculate a correlative integration value with respect to a reception signal from a base station as hand-over origin and into a group to calculate a correlative integration value with respect to a reception signal from a base station as hand-over destination.
